(19) United States
(12) Patent Application Publication
(10) Pub. No.: US 2007/0072477 A1
(43) Pub. Date: Mar. 29, 2007

(54) CABLE GUIDE WITH STRUCTURAL GRAPHICAL ELEMENTS

(75) Inventors: Martin S. DIECK, Menlo Park, CA (US); Nicholas C. DEBEER, Menlo Park, CA (US)

Correspondence Address: LEVINE BAGADE HAN LLP, 2483 EAST BAYSHORE ROAD, SUITE 100, PALO ALTO, CA, 94303, US

(73) Assignee: Dirty Dog MTB, Inc., Montara, CA (US)

(21) Appl. No.: 11/535,037

(22) Filed: Sep. 25, 2006

Related U.S. Application Data
(60) Provisional application No. 60/720,723, filed on Sep. 27, 2005.

(51) Int. Cl. H01R 11/20

(52) U.S. Cl. 439/394

(57) ABSTRACT

Cable guides are provided that include an extended outer surface depicting a graphical element, behind which is set a volume for receipt of a cable and/or cable housing. They combine structural and graphical elements. In one variation, the extended surface is a convex surface modeled in the shape of a skull. A cavity is formed in the volume provided behind the convex surface to receive a cable or cable housing. The cable housing area may be in the form of an open channel or closed lumen.

### CROSS-REFERENCE

This application claims the benefit of Provisional Patent Application Ser. No. 60/720,723, entitled “Bicycle Cable Guide with Structural Graphical Elements” filed Sep. 27, 2005, the content of which is incorporated herein by reference in its entirety.

### BACKGROUND

Bicycle component manufacturers, such as Problem Solvers and A2Z Components, manufacture cable guides for bicycles as do frame manufacturers. These cable guides are configured with simple geometric shapes to hold the cables (most often disc brake cables) in place to the front fork or to the frame while riding so they do not get caught in any moving components or snag anything on the side of the trail or road. Many bicyclists simply use electrical cable guides to hold the cable in place. Others may use zip ties (alone), or even one or more wraps of electrical tape.

Apart from cyclists who lack imagination beyond counting grams, (i.e., a group whose minimalist ethos has caused them to be referred to as “weight weenies”), consumers might desire a more interesting set of options in cable restraint. The present invention meets this need and others, including general humor, as those with skill in the art will appreciate upon review of this filing.

### SUMMARY OF THE INVENTION

The present invention relates to cable guides. More particularly, the present invention relates to cable guides with structural graphical elements suitable for vehicles including, but not limited to, bicycles and motor driven cycles such as mopeds, scooters, and motorcycles. In their preferred implementation, as one will see, they are more likely to be used by “cool” people in connection with mountain bikes, or customized “chopper” motorcycles, however the invention may be used by anyone on any vehicles that uses cable guides.

A consumer may typically select from any of a number of variations of the present invention to secure his or her bike cables and/or to make a personal statement. These goals may be accomplished by use of the subject invention by virtue of the cable guides dual function. On an exterior surface, it may display a graphical representation or image, and a lumen or channel may be provided interior to the image for receipt of at least one cable or cable housing.

Numerous variations may be possible according to the present invention. The graphical image may be, for example, a Nuclear Radiation, Toxic, Poisonous or Caustic Chemical warning symbol. Because it may have greater impact than a mundane warning (mundane at least in view of the intended user), the image may depict a macabre element, such as a skull, a shrunken head, a zombie, or another garish figure. The image may even be crude or gross, such as in the form of butt cheeks or dog poop. In a preferred embodiment, a primitive monkey skull is depicted. Now, that is an image to which the intended biker which the assignee hereto caters can relate.

However, more refined and/or sophisticated depictions (refined and/or sophisticated at least in view of the intended user) are contemplated. In addition, icons such as flowers, berries, ferries, Snow White, her dwarves or various other flora, fauna, etc. may be depicted.

Regardless of the image, the cable receipt is accommodated behind the graphical features. In preferred variations, the cable receipt area comprises a concave opening, such as a slot or trench, such that the cable guide may be set in place over the cable. Alternately, an enclosed lumen may be provided. In which case some disassembly, or coordinated assembly, may be required to fit the cable guide over the cable.

Whatever the case, the cable guide may be secured to the vehicle, (including its frame, fork, etc.) in any of a number of ways. In one variation adhesives (e.g., double-sided foam tape) may be employed. In which case, the “back” side of the cable guide may be undercut to conform to a tube over which it is placed. Whether undercut or not, the cable guide may include a transverse through hole for receipt of a zip tie or another type of tie-down. In yet another variation (not shown), a track may be provided for at least one zip tie so that the tie itself appears as a figural detail. For example, it may appear to be a cord wrapped around-the neck of a choking head (or even a body that includes arms and hands trying to save itself from a nasty fate as it turns blue). Alternatively, an elastic member (such as an o-ring) may be hooked over bosses to secure the cable guide. Other approaches may be used as well, or some combination thereof, in belt-and-suspenders type fashion.

Suffice it to say, the subject to be portrayed can be executed in any of a number of ways. Nonetheless, the bodies according to the present invention that incorporate graphical images that effectively hold and/or secure the cables to the front fork or frame as well any other component that simply lacks visual interest. The cost of such expression may be a mere few grams of weight (typically about 2 to about 10 g).

### BRIEF DESCRIPTION OF THE DRAWINGS

FIG. 1 shows a cable guide according to the present invention installed on the fork of a mountain bike, together with an enlarged view of the cable guide.

FIGS. 2A-2D show the cable guide in FIG. 1 as seen from the front, side, above, and below, respectively, to better illustrate aspects of the design.

Further variation of the invention may be contemplated from the example shown.

### DETAILED DESCRIPTION

Generally speaking, cable guides (alternatively, “cableguides”) typically have a minimum of two main areas. The first area is where it attaches to the front fork or the frame of a vehicle. The second area is the part that holds the cable. In the present invention, a third area is provided in the form of an outer surface that bears a graphical image or figure.

The invention incorporates graphical images in the relevant body of the cable guide, as opposed to using graphic features outside of the relevant body, such as hanging off of the cable guide main body or block. Graphical details and/or full images may also be laser etched (or imparted by other marking techniques) into the surface of the cable guides.

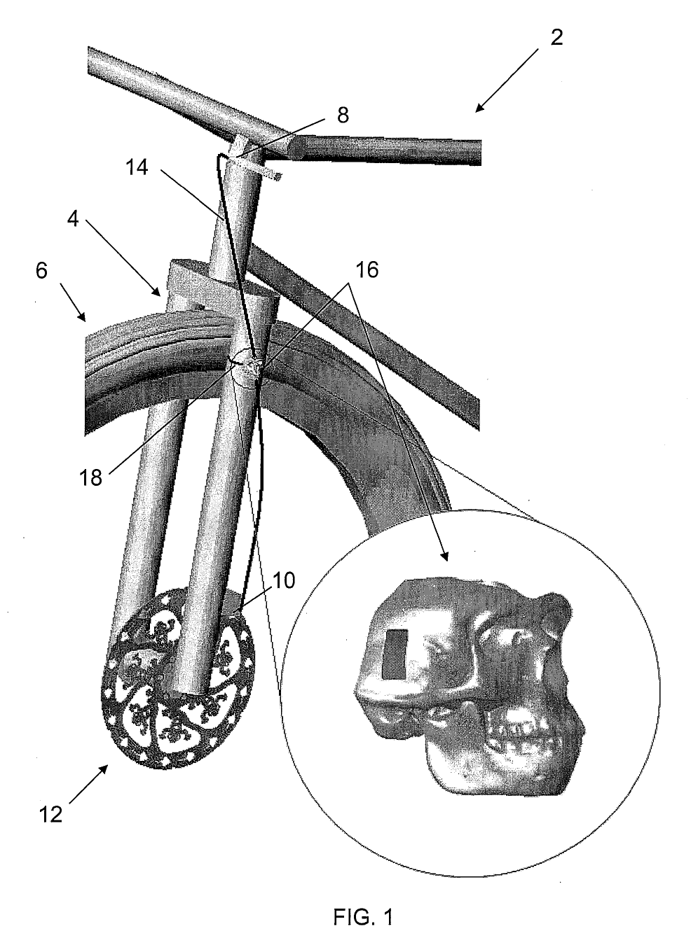

In reference to the figures, FIG. 1 shows a mountain bike frame 2, including a fork assembly (rigid or suspension) 4. A wheel 6 is held by the fork. Front brake lever assembly 8 is shown for actuating a disc brake caliper assembly 10 for slowing and/or stopping the bike in connection with rotor 12 (preferably, a Dirty Dog, Inc. rotor as shown, although any rotor may be used). A cable or hydraulic fluid within a cable housing (alternatively referred to simply as a cable) 14 typically transmits force applied by the user to brake.

A cable guide 16 secures cable/cable housing 14 to the fork. Other uses or locations are possible as well. But for the purposes of illustration, the cable is shown in a position with little slack and substantially stabilized by the cable guide. One or more cable guides may be advantageously used in this fashion.

Cable guide 16 may be secured to the fork (its upper stanchion, and/or its leg) by a zip-tie 18 or other means. Preferably, the tie-down element passes through apertures along the sides of the cable guide as shown and discussed in further detail below in specific reference to the cable guide.

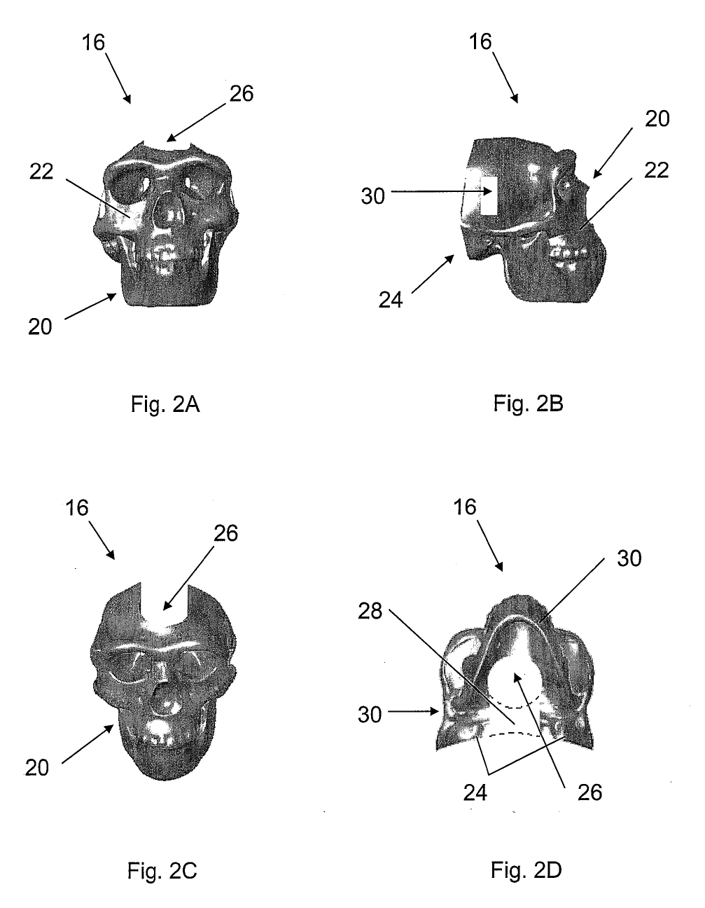

For such discussion, reference is made to FIGS. 2A-2D. Here, detailed views are provided of a cable guide comprising an extended outer surface depicting a graphical element, behind which is set a volume for receipt of a cable and/or cable housing. In the variation shown, the extended surface is a convex surface modeled in the shape of a skull. An elongate cavity is formed in the volume provided behind the convex surface. The open area may be in the form of an open channel or closed lumen.

More specifically, outer surface 20 includes, depicts, and/or incorporates a graphical element or image 22 (in this case, a skull). An inner surface 24 of the cable guide may interface with the fork or another frame element. A cable channel 26 is adapted to receive a cable and/or cable housing. By this, what is meant is that it is sized to approximately fit (i.e., as in a press fit, close fit or slip fit—preferably, though not necessarily) cable housing 14. Of course, for different applications (e.g., bicycles vs. motorcycles), the sizing will differ.

As shown in FIGS. 2A-2D, the channel 26 shown is open along its length with a wall defined by inner surface 24. In another variation, as illustrated in FIG. 2D, an optional web section 28 may be provided, in which case the cable will be received within a closed lumen. Moreover, the body for receipt or in receipt of the cable housing need not be a full channel or lumen. Rather, the material adjacent to the smallest diameter portion or portions may be undercut so that the cable housing is held or received by one or more ring or U-shaped sections.

Likewise, surface 24 may be or may not be a full or smooth surface as shown. A smooth surface may facilitate adhering to double-stick foam tape (or some other form of adhesive or adhesive member) to attach cable guide 14 to a tubular structure (e.g., fork slider, stanchion, and/or frame tube member).

Given that the cable guide may typically be used to secure a cable running in-line with such a tubular body, any concave feature of the guide and the channel or lumen 26 will typically be aligned. Such an arrangement may be advantageous in that the outer surface 20 depicting graphical image 22 is (generally and/or overall) convex so as to provide space for the negative space (i.e., concave) features.

In any case, a concave back to the cable guide may be preferably configured so that it includes two sides or “wings” on either and/or opposite sides of the channel. Such an arrangement typically offers a highly stable body and/or attachment scheme.

For attachment via a cable tie or “zip” tie, a lumen 30 is provided, typically, at 90 degrees or at least substantially transverse to channel 26. The lumen 30 may have a rectangular profile adapted to closely fit a zip tie, however any shaped profile may be used. The lumen 30 may be set in front of or behind the intended location for the cable guide. Generally, it may be preferred to locate it as shown (aft of the central cable location) to avoid the possibility of its presence interfering with graphical features of the front and/or outer surface 20. To possibly further aid in this respect, the lumen may be curved and/or offer angled exit points to assist with setting the lumen as close to inner surface 24 as possible. Naturally, lumen 30 may be provided as an integrally molded feature, or it may comprise a covered channel or trench.

As for the overall “fit” of the various features (both graphical and/or structural), reference to the figures shows a highly coordinated example in the case of the skull. The concave and convex feature fit, as detailed above, is most apparent in reference to FIGS. 2C and 2D. Especially in reference to FIG. 2D, one may observe the space efficiency of the design in which cable channel 26 is nestled into the outline of the skull's jawbone 32. In this way, the cable guide offers a three-dimensionally sculptured body, with wonderful detail as viewed from any direction. However, while such detail is desirable and preferred in embodiments according to the present invention, more crude renditions are possible.

However they are graphically designed, in construction, the cable guides may be machined, forged or otherwise formed in metal such as aluminum or magnesium alloy. Still, for reasons of cost and/or weight savings, they preferably comprise injection molded plastic—such as ABS, PVC or Nylon. Still, any method of manufacture or material may be selected. Some cable guides may be made of multiple materials fastened and/or bonded (by gluing, welding, etc.) together. Such an approach may be desirable from the perspective of offering interchangeable face plates (such as happy, sad, or angry face masks to a cable guide shaped like a head, etc.).

Variations

The invention includes methods that may be performed using the subject devices or by other means. The methods may all comprise the act of providing a suitable device. Such provision may be performed by the end user. In other words, the “providing” (e.g., a delivery system) merely requires the end user obtain, access, approach, position, set-up or otherwise proceed to provide the requisite device in the subject method.

Exemplary aspects of the invention, together with details regarding material selection and manufacture have been set forth above. Though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of brevity) may be substituted without departing from the true spirit and scope of the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of the claim language in its broadest possible sense, unless explicitly stated otherwise during the prosecution of this patent.

We hereby claim:

1. A cable guide comprising:
an outer surface depicting a graphical element, an inner surface, and a cable channel adapted to receive a cable.

2. The cable guide of claim 1, wherein the channel is open along its length and defined by the inner surface.

3. The cable guide of claim 1, wherein the channel comprises a lumen formed between the inner and outer surfaces.

4. The cable guide of claim 1, wherein the inner surface includes at least one curved section adapted to interface with round tubing.

5. The cable guide of claim 4, wherein two curved sections on opposite sides of the channel.

6. The cable guide of claim 1, further comprising a lumen transverse to the cable channel.

7. The cable guide of claim 6, wherein the lumen has a rectangular profile adapted to closely fit a zip tie.

8. The cable guide of claim 1, wherein the outer surface is substantially convex.

9. The cable guide of claim 8, wherein the substantially convex surface includes features to depict a head.

10. The cable guide of claim 9, wherein the head comprises a skull.

11. The cable guide of claim 10, wherein the skull includes a jaw bone and the channel is nested within the jaw bone.

12. A cable guide assembly comprising:
the cable guide of claim 1, and a tie passing through a lumen transverse to the channel and located between the inner and outer surfaces, the tie locking the inner surface to a tubular element of a bicycle or motor driven cycle.

13. A system comprising:
a cable guide comprising an outer surface depicting a graphical element, an inner surface, and a cable channel adapted to receive a cable; and
a vehicle.

14. The system of claim 15, wherein the channel is open along its length and defined by the inner surface.

15. The system of claim 15, wherein the channel comprises a lumen formed between the inner and outer surfaces.

16. The system of claim 15, further comprising a lumen transverse to the cable channel.

17. The system of claim 15, wherein the outer surface is substantially convex.

18. The system of claim 15, further comprising a tie passing through a lumen transverse to the channel and located between the inner and outer surfaces, the tie locking the inner surface to a tubular element of the vehicle.

19. The system of claim 15, wherein the vehicle is a bicycle.

20. The system of claim 15, wherein the vehicle is a motor driven cycle.
